(19) United States
(12) Patent Application Publication
(10) Pub. No.: US 2008/0030004 A1
(43) Pub. Date: Feb. 7, 2008

(54) Trailer extension for multiple recreational vehicles

(76) Inventor: Robert Rempel, (US)

Correspondence Address: JAMES RAY & ASSOCIATES, 2640 PITCAIRN ROAD, MONROEVILLE, PA, 15146, US

(21) Appl. No.: 11/890,209

(22) Filed: Aug. 3, 2007

Related U.S. Application Data
(60) Provisional application No. 60/835,817, filed on Aug. 4, 2006.

(51) Int. Cl. B62D 63/06

(52) U.S. Cl. 280/656

(57) ABSTRACT

A trailer extension, detachable at both ends, includes an elongated rigid beam with trailer hitches secured at both ends, the rear one for hooking to a standard trailer such as a boat trailer. A secondary support member is removably clamped underneath the elongated rigid beam and underneath the frame of the following trailer to distribute added weight. At least one platform section is supported on top of and intermediate to the ends of the elongated rigid beam. At least one ramp is hingedly or removably attached to one side of the transverse platform section such that recreational vehicles can be driven up onto the platform.

### CROSS REFERENCE TO RELATED APPLICATION

This patent application is related to and claims priority from U.S. Provisional Patent Application Ser. No. 60/835,817 filed Aug. 4, 2006.

### FIELD OF THE INVENTION

The present invention relates, in general, to transport of recreational vehicles and, more particularly, this invention relates to boat trailer front-end extensions for adding capacity to also tow other recreational vehicles.

### BACKGROUND OF THE INVENTION

Many outdoor enthusiasts enjoy traveling and participating in multiple outdoor activities as well. Boating is a common one, but riding all-terrain vehicle (ATV's) and motorcycles provide other sources of recreation. Prior to the conception and development of the present invention, vacationers and weekend travelers taking a boat along have had to choose between taking a second towing vehicle or leaving some recreational vehicles at home.

The concept of towing or carrying other vehicles in combination with a boat has been described in some prior art. U.S. Pat. No. 3,989,265 teaches a boat trailer modification for carrying at least one motorcycle. In U.S. Pat. No. 5,505,514, Green discloses a camper/boat trailer combination. In both of these prior art cases, there is one integral trailer assembly; there are no sections that disconnect. U.S. Pat. No. 5,069,471 teaches a trailer combination for hauling a boat behind a camping trailer with a four-wheel carriage between the two. Besides the special four-wheel carriage, a hydraulic device is mounted beneath the boat trailer to raise and lower its wheels.

In U.S. Pat. No. 3,751,073, Alexander discloses a detachable trailer extension for carrying a wheeled trailer with its wheels off the roadway when it is being transported. To remove the trailer, the task of disconnecting the extension and lowering it to the ground must be performed. The notion of trailer sections in tandem was also disclosed in U.S. Pat. No. 1,860,518, but in this example, one set of wheels for each vehicle being towed had to be on the roadway. Hence, there appear to be drawbacks in the entire prior art.

### SUMMARY OF THE INVENTION

The present invention provides a trailer extension, detachable at both ends, and includes an elongated rigid beam with trailer hitches secured at both ends, the rear one for hooking to a standard trailer such as a boat trailer. A secondary support member is removably clamped underneath the elongated rigid beam and underneath the frame of a following trailer. At least one platform section is supported on top of and intermediate to the ends of the elongated rigid beam. At least one ramp is hingedly or removably attached to one side of the transverse platform section such that recreational vehicles can be driven up onto the platform.

In an alternative embodiment of the present invention, a plurality of reinforcing truss members are attached adjacent to the ends of the elongated rigid beam, and help to support at least one transverse platform section securely on top. A retractable wheel assembly is attached near the rear trailer hitch. A ramp is pivotally attached to some part of the transverse platform section to enable recreational vehicles to be driven into position for transport.

### OBJECTS OF THE INVENTION

It is, therefore, one of the primary objects of the present invention to provide additional, but optional, towing capability behind a towing vehicle.

Another object of the present invention is to provide a separable extension in tandem with a standard trailer for concurrently carrying recreational vehicles such as ATV's and dirt bikes.

Still another object of the present invention is to provide an alternative trailer extension with retractable wheels such that the extension can function as a stand-alone trailer.

Yet another object of the present invention is to provide an economical means of transporting a variety of recreational vehicles in combination with a boat using only one towing vehicle.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of an embodiment of the present invention in tandem with a typical boat trailer.

FIG. 2 is a perspective view of an alternative embodiment of the present invention that can be used in tandem with another trailer or by itself.

FIG. 3 is a front elevation view illustration a variation whereby a platform also serves as a drive-on ramp.

### DETAILED DESCRIPTION OF A PRESENTLY PREFERRED AND ALTERNATIVE EMBODIMENT OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

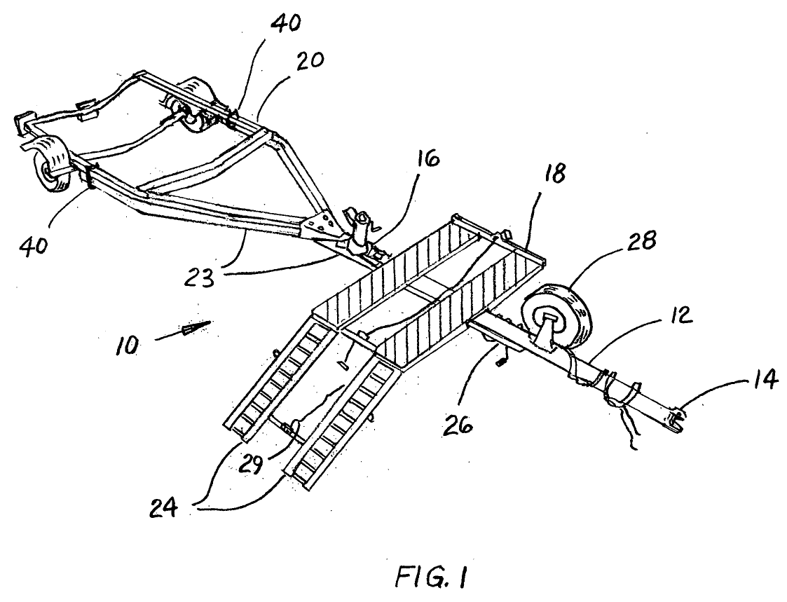

Referring initially to FIG. 1, the auxiliary trailer extension 10 is shown in isometric view connected to a standard boat trailer 20 at the hitch connection 16. A sturdy elongated beam 12 has a hitch 14 at the front end for hooking up to a towing vehicle. A Y-shaped secondary support member 23 is clamped underneath the main beam 12 and the frame of the boat trailer 20 with clamps 40. This secondary support transfers some of the weight near the boat hitch to the boat trailer wheels. The main utility of the trailer extension is derived from the stationary platform 18 fixed transversely on top of the elongated beam 12. With the aid of at least one ramp 24, preferably two as shown, an all-terrain vehicle (ATV), golf cart or up to two motorcycles can be loaded on and then transported by the trailer extension. A cable rope or chain 27 secures the vehicle to the platform once loaded. A tie bar and attached rope 29 between the two ramps 24 provide a means to hold the ramps in the up position after loading. A crank-down stand 26 can keep the front end elevated when the extension is disconnected from the towing vehicle. As an option, a mount for carrying a spare tire 28 is attached to the main beam 12.

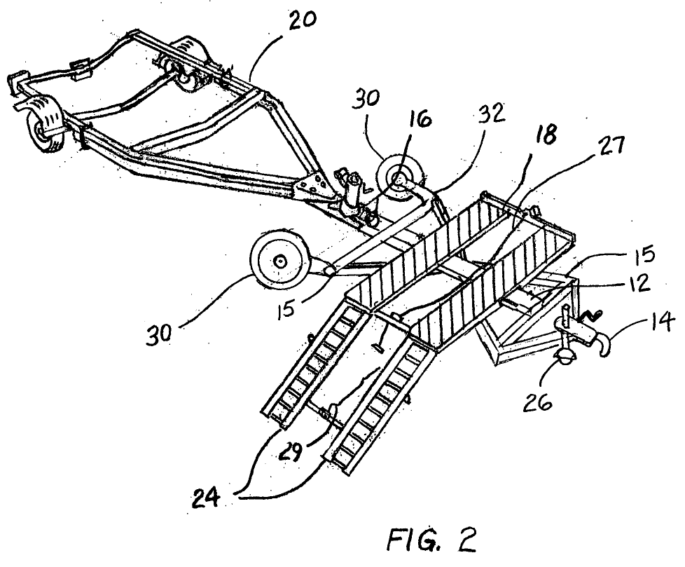

FIG. 2 depicts an alternative embodiment of the present invention. A central beam 12 has a trailer hitch 14 in the front for connecting to a towing vehicle and a rear hitch 16 mating to a standard boat trailer hitch. Perpendicular cross members and angle braces 15 strengthen the structure and provide support underneath the vehicle platform 18. Two ramps 24 permit a recreational vehicle to be driven onto the platform 18, and the ramps are then swung up and secured in place with the cross member and attached rope 29. Two spare tires 30 are removably attached to a retractable wheel assembly 32. The tires 30 are normally not touching the pavement, but they can be lowered when it is desirable to disconnect the boat trailer 20, and/or use the trailer extension by itself to transport a recreational vehicle without the boat. Adjacent the front hitch 14, there is a crank-down stand 26 for supporting the trailer assembly when disconnected from the towing vehicle.

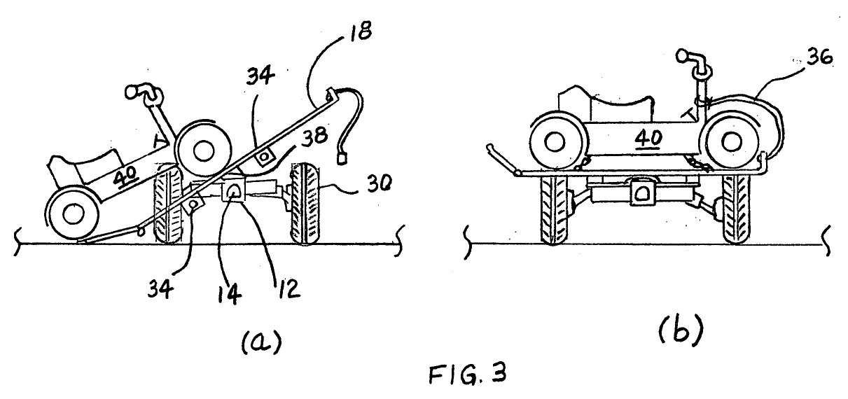

FIG. 3 provides an elevation end view of a variation of the design shown in FIG. 2. The spare tires 30 are shown in the optional down position. In this case, the recreational vehicle support platform 18 is preferably all one piece and also serves as the ramp for loading the vehicle 35. A pivoting saddle-like device 38 underneath the platform 18 and on top of the central beam 12 enables the platform 18 to be tilted to touch the ground on one side. The recreational vehicle 35 is then driven up the ramp 18, and when it approaches the far side, its weight causes the ramp 18 to pivot into a horizontal position. Brackets 34 underneath the ramp 18 enable it to be secured in place with rods or bolts that connect to the angle braces 15. Chains, ropes, or belts 36 then secure the vehicle 35 in place.

While a presently preferred and an alternative embodiment of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. A trailer extension, detachable at both ends, comprising:
a) an elongated rigid beam;
b) trailer hitches secured at each end of said elongated rigid beam;
c) a secondary support means removably secured underneath said elongated rigid beam and a frame of a following trailer for distributing weight;
d) at least one platform section fixedly supported on top of and intermediate to ends of said elongated rigid beam ; and
e) a means for driving a vehicle onto said platform section attached to one side of said platform section.

2. The trailer extension, according to claim 1, wherein one of said trailer hitches mates with a typical hitch connection on a boat trailer.

3. The trailer extension, according to claim 1, wherein one of said trailer hitches mates to a conventional hitch connection on a towing vehicle.

4. The trailer extension, according to claim 1, wherein said at least one platform section is a pair of elongated ramps transversely mounted in parallel and spaced at a distance substantially equivalent to wheel spacing on a typical all-terrain vehicle.

5. The trailer extension, according to claim 1, wherein said elongated rigid beam has a retractable stand proximal foremost of said trailer hitches.

6. The trailer extension, according to claim 1, wherein a spare tire carrier is secured to said elongated rigid beam.

7. The trailer extension, according to claim 1, wherein said means for driving a vehicle onto said platform section is at least one ramp hingedly attached to one side of said platform section.

8. The trailer extension, according to claim 1, wherein said means for driving a vehicle onto said platform section is at least one stowable ramp removably attached to one side of said platform section.

9. The trailer extension, according to claim 1, wherein said secondary support means is a Y-shaped structure clamped underneath a frame of a boat trailer.

10. The trailer extension, according to claim 1, wherein said secondary support means is a straight beam clamped underneath a frame of said following trailer.

11. A trailer extension, detachable at both ends, comprising:
a) an elongated rigid beam
b) trailer hitches secured at each end of said elongated rigid beam;
c) a plurality of reinforcing plates and truss members attached adjacent to ends of said elongated rigid beam;
d) at least one platform section securely supported on top of and intermediate to said elongated rigid beam;
d) a retractable wheel assembly attached proximal said trailer hitch at rear end of said trailer extension; and
e) a ramp-creating means pivotally attached to said platform section for enabling a recreational vehicle to be driven onto and down from said platform section.

12. The trailer extension, according to claim 11, wherein said at least one platform section is a pair of elongated ramps transversely mounted in parallel and spaced at a distance substantially equivalent to wheel spacing on a typical all-terrain vehicle.

13. The trailer extension, according to claim 11, wherein said ramp-creating means is least one ramp hingedly attached to one outside edge of said at least one platform section.

14. The trailer extension, according to claim 11, wherein said ramp-creating means is a see-saw like mechanism pivotally attached proximal centers of both said elongated rigid beam and said platform section so as to permit said platform section to rotate in one direction and touch ground.
